(19) United States
(12) Patent Application Publication
(10) Pub. No.: US 2026/0149334 A1
(43) Pub. Date: May 28, 2026

(54) VARIABLE-CAPACITY ELECTRIC PROPULSION MOTOR COOLING STRUCTURE AND VARIABLE-CAPACITY ELECTRIC PROPULSION MOTOR EQUIPPED THEREWITH

(71) Applicant: KOREA INSTITUTE OF OCEAN SCIENCE & TECHNOLOGY, Busan (KR)

(72) Inventors: Soyoung SUNG, Seoul (KR); Junghyung PARK, Gwangju (KR); Hyungwon SHIM, Sejong-si (KR); Yunho KIM, Daejeon (KR)

(21) Appl. No.: 19/102,646

(22) PCT Filed: Jul. 6, 2023
(86) PCT No.: PCT/KR2023/009614

§ 371 Date: Feb. 10, 2025

(30) Foreign Application Priority Data
Aug. 8, 2022 (KR) 10-2022-0098482

(51) Int. Cl. H02K 9/19; H02K 1/12; H02K 1/27; H02K 7/00

(52) U.S. Cl. CPC H02K 9/19; H02K 1/12; H02K 1/27; H02K 7/003

(57) ABSTRACT

A variable-capacity electric propulsion motor cooling structure according to the present invention is a structure for cooling a variable-capacity electric propulsion motor comprising: a rotor shaft; a rotor core having the shape of a circular plate such that the rotor shaft is coupled through the center thereof, multiple permanent magnets buried along the circumferential direction of the rotor core; a winding coil disposed so as to surround the outer periphery of the rotor core; a stator core disposed so as to surround the outer periphery of the winding coil so as to undergo a magnetic force reaction with the permanent magnets; a motor housing disposed so as to surround the outer periphery of the stator core in a hollow cylinder shape, both sides of the motor housing being open; and a pair of covers coupled to both open sides of the motor housing, respectively, such that the rotor shaft is coupled through the center of each cover, a containing space being formed inside each cover. Multiple cooling holes are formed at a predetermined interval along the circumferential direction through both surfaces of the stator core positioned in the same direction as the axial direction of the rotor shaft. Cooling tubes are coupled to the multiple cooling holes, respectively. Cooling water introduced through one of the pair of covers is discharged through the other cover after passing through the cooling tubes.

### TECHNICAL FIELD

The present disclosure relates to a variable-capacity electric propulsion motor cooling structure and a variable-capacity electric propulsion motor equipped therewith. In particular, the present disclosure relates to a variable-capacity electric propulsion motor cooling structure that can maximize cooling efficiency without affecting motor characteristics and eliminates the need for additional cooling structure design according to variable capacity, as well as to a variable-capacity electric propulsion motor equipped with the variable-capacity electric propulsion motor cooling structure.

### BACKGROUND ART

Electric motors are broadly classified into direct current (DC) motors and alternating current (AC) motors.

DC motors rotate by receiving direct current supplied to the armature (rotor) and include series motors, shunt motors, and compound motors.

AC motors rotate using an alternating current power supply and include induction motors, synchronous motors, and AC commutator motors.

These types of motors consume electrical energy in their coils due to the supplied power and, typically generate heat during operation, because these motors operate at high speeds.

The heat generated can adversely affect the operating characteristics of the motor and, in severe cases, result in issues such as coil burnout.

Accordingly, significant researches have been conducted in the past to cool the heat generated by motors.

FIG. 1 illustrates an exploded view of a housing integrated with a cooling device in a cooling structure for a motor according to the conventional art, and FIG. 2 is a cross-sectional view of a cooling structure for a motor according to the conventional art.

The conventional cooling structure for electric motors, as shown in FIGS. 1 and 2, has a structure in which a cooling device for cooling the stator 10 is integrated with the housing 20. The cooling structure is characterized by the formation of grooved and embossed flow paths 22 on the inner circumferential surface of the housing 20 to be in close contact with the outer surface of the stator 10 without any gaps.

In addition, the cooling water supply means includes cooling water supply holes 24 for supplying cooling water at both ends of each flow path 22. The cooling water supply means also include an end portion 25 having a water collection part 25a configured to collect the cooling water at both ends of the housing 20 and to supply the cooling water into the flow path 22 through the cooling water supply holes 24.

The integrated housing 20, which incorporates the cooling device, is designed such that there is no gap between the inner circumferential surface of the housing 20 and the stator 10. Since the flow path 22 through which cooling water flows is in surface contact with the outer surface of the stator 10, the heat generated during the operation of the motor is cooled.

However, such a conventional cooling structure for electric motors has the drawback that the cooling efficiency is reduced because the structure, integrated into the housing, places the heat-generating elements (such as winding coils or permanent magnets) at a distance. Furthermore, the complex structure required for cooling increases manufacturing costs.

Moreover, the conventional cooling structure for electric motors has the problem of being difficult to adapt to variable motor capacities, as it is not easy to tailor the cooling structure to match different capacities.

### DISCLOSURE

### Technical Problem

The present disclosure has been devised to address the various aforementioned problems of the prior art. The purpose of the present disclosure is to provide a variable-capacity electric propulsion motor cooling structure that can maximize cooling efficiency without affecting motor characteristics and eliminates the need for additional cooling structure design according to variable capacity, as well as to a variable-capacity electric propulsion motor equipped with the variable-capacity electric propulsion motor cooling structure.

### Technical Solution

In order to achieve the purpose, an aspect of the present disclosure provides a cooling structure for cooling a variable-capacity electric propulsion motor, the variable-capacity electric propulsion motor comprising: a rotor shaft; a rotor core formed in a shape of a circular plate, with the rotor shaft penetrating and being coupled at a center of the rotor core; a plurality of permanent magnets embedded along a circumferential direction of the rotor core; a winding coil arranged to surround an outer circumference of the rotor core; a stator core arranged to surround an outer circumference of the winding coil and to perform magnetic interaction with the plurality of permanent magnets; a motor housing formed in a hollow cylindrical shape with both ends open, arranged to surround an outer circumference of the stator core; and a pair of covers, each coupled to each of the both open ends of the motor housing, with the rotor shaft penetrating and being coupled at a center of each of the pair of covers, and with an accommodation space formed in the pair of covers, wherein the stator core is located in a same direction as an axis of the rotor shaft, wherein a plurality of cooling holes are formed at regular intervals along a circumferential direction of the stator core by penetrating through both faces of the stator core, wherein a plurality of cooling tubes are respectively coupled to the plurality of cooling holes, and wherein a cooling water introduced through one of the pair of covers flows through the cooling tubes and is discharged through another of the pair of covers.

In some exemplary embodiments, each of the pair of covers may include: an inner cover coupled to an open side of the motor housing; and an outer cover formed in a shape corresponding to the inner cover and coupled to the inner cover.

In some exemplary embodiments, the inner cover may include: a base portion covering the open side of the motor housing; and an edge portion extending a predetermined length in an axial direction of the rotor shaft from a perimeter of the base portion.

In some exemplary embodiments, the base portion may include a plurality of fitting holes formed at positions corresponding to the plurality of cooling tubes, and ends of the plurality of cooling tubes may be respectively fitted into the plurality of fitting holes.

In some exemplary embodiments, the base portion may include a heat dissipating portion formed to release heat generated in the variable-capacity electric propulsion motor.

In some exemplary embodiments, the heat dissipating portion may include: a first protruding rib extending from the base portion in a same direction as the edge portion along a perimeter of the rotor shaft; a second protruding rib located between the first protruding rib and the fitting holes, extending from the base portion and formed in a same shape as the first protruding rib; and a plurality of heat dissipating ribs, each of which is spaced apart from one another and connecting the first protruding rib and the second protruding rib.

In some exemplary embodiments, the outer cover may be formed to cover a space between the second protruding rib and the edge portion.

In some exemplary embodiments, a cooling water inlet may be formed at one of a pair of the inner covers, and a cooling water outlet may be formed at another one of the pair of the inner covers.

In addition, in order to achieve the purpose, another aspect of the present disclosure provides a variable-capacity electric propulsion motor, comprising: a rotor shaft; a rotor core formed in a shape of a circular plate, with the rotor shaft penetrating and being coupled at a center of the rotor core; a plurality of permanent magnets embedded along a circumferential direction of the rotor core; a winding coil arranged to surround an outer circumference of the rotor core; a stator core arranged to surround an outer circumference of the winding coil and to perform magnetic interaction with the plurality of permanent magnets; a motor housing formed in a hollow cylindrical shape with both ends open, arranged to surround an outer circumference of the stator core; and a pair of covers, each coupled to each of the both open ends of the motor housing, with the rotor shaft penetrating and being coupled at a center of each of the pair of covers, and with an accommodation space formed in the pair of covers, wherein the stator core is located in a same direction as an axis of the rotor shaft, wherein a plurality of cooling holes are formed at regular intervals along a circumferential direction of the stator core by penetrating through both faces of the stator core, and wherein a plurality of cooling tubes are respectively coupled to the plurality of cooling holes.

In some exemplary embodiments, each of the pair of covers may include: an inner cover coupled to an open side of the motor housing; and an outer cover formed in a shape corresponding to the inner cover and coupled to the inner cover.

In some exemplary embodiments, the inner cover may include: a base portion covering the open side of the motor housing; and an edge portion extending a predetermined length in an axial direction of the rotor shaft from a perimeter of the base portion.

In some exemplary embodiments, the base portion may include a plurality of fitting holes formed at positions corresponding to the plurality of cooling tubes, and ends of the plurality of cooling tubes may be respectively fitted into the plurality of fitting holes.

In some exemplary embodiments, the base portion may include a heat dissipating portion formed to release heat generated in the variable-capacity electric propulsion motor.

In some exemplary embodiments, the heat dissipating portion may include: a first protruding rib extending from the base portion in a same direction as the edge portion along a perimeter of the rotor shaft; a second protruding rib located between the first protruding rib and the fitting holes, extending from the base portion and formed in a same shape as the first protruding rib; and a plurality of heat dissipating ribs, each of which is spaced apart from one another and connecting the first protruding rib and the second protruding rib.

In some exemplary embodiments, the outer cover may be formed to cover a space between the second protruding rib and the edge portion.

In some exemplary embodiments, a cooling water inlet may be formed at one of a pair of the inner covers, and a cooling water outlet may be formed at another one of the pair of the inner covers.

In some exemplary embodiments, a bearing may be coupled between the rotor shaft and the first protruding rib.

In some exemplary embodiments, the cooling water inlet may be formed at a non-driven end of the variable-capacity electric propulsion motor, and the cooling water outlet may be formed at a driven end of the variable-capacity electric propulsion motor.

In some exemplary embodiments, the cooling water may flow from the non-driven end to the driven end.

In some exemplary embodiments, a capacity of the variable-capacity electric propulsion motor varies according to a laminated length depending on a number of the rotor core and the stator core being laminated.

Specific details of other exemplary embodiments are included in “Details for carrying out the invention” and accompanying “drawings”.

Advantages and/or features of the present disclosure, and a method for achieving the advantages and/or features will become obvious with reference to various exemplary embodiments to be described below in detail together with the accompanying drawings.

However, the present disclosure is not limited only to a configuration of each exemplary embodiment disclosed below, but may also be implemented in various different forms. The respective exemplary embodiments disclosed in this specification are provided only to complete disclosure of the present disclosure and to fully provide those skilled in the art to which the present disclosure pertains with the category of the present disclosure, and the present disclosure will be defined only by the scope of each claim of the claims.

### Advantageous Effects

According to the means for solving the aforementioned problems, the present disclosure provides the following advantages:

The present disclosure achieves the effect of maximizing cooling efficiency without affecting motor characteristics by forming multiple cooling holes in the stator core and configuring the cooling structure to couple cooling tubes to these cooling holes.

In addition, as the present disclosure pertains to an interior permanent magnet-type electric propulsion motor with a structure in which the capacity is variable based on the laminated length, thus eliminating the need for additional cooling structure design for variable capacities.

### DESCRIPTION OF DRAWINGS

FIG. 1 illustrates an exploded view of a housing integrated with a cooling device in a cooling structure for a motor according to the conventional art.

FIG. 2 is a cross-sectional view of a cooling structure for a motor according to the conventional art.

FIG. 3 illustrates a shape of a general variable-capacity electric propulsion motor.

FIG. 4 illustrates a variable-capacity electric propulsion motor according to an exemplary embodiment of the present disclosure.

FIG. 5 illustrates a state where a cooling tube is coupled to the stator core in the variable-capacity electric propulsion motor according to an exemplary embodiment of the present disclosure.

FIG. 6 illustrates an interior of an inner cover in the variable-capacity electric propulsion motor according to an exemplary embodiment of the present disclosure.

FIG. 7 illustrates an assembled state where a stator core, a winding coil, a rotor core, and a permanent magnet are coupled with the cooling tube in the variable-capacity electric propulsion motor according to an exemplary embodiment of the present disclosure.

FIG. 8 illustrates a state where a stator core with cooling holes, a rotor core, and a permanent magnet are coupled in the variable-capacity electric propulsion motor according to an exemplary embodiment of the present disclosure.

FIG. 9 illustrates the stator core in the variable-capacity electric propulsion motor according to an exemplary embodiment of the present disclosure.

FIG. 10 illustrates an assembled state of a stator core, a rotor core, and a permanent magnet, as well as the magnetic flux distribution, in a general electric propulsion motor.

FIG. 11 illustrates an assembled state of a stator core, a rotor core, and a permanent magnet, as well as the magnetic flux distribution, in the variable-capacity electric propulsion motor according to an exemplary embodiment of the present disclosure.

FIG. 12 illustrates a cooling structure of a variable-capacity electric propulsion motor according to an exemplary embodiment of the present disclosure.

FIGS. 13 through 15 illustrate cooling structures corresponding to variable capacities, where FIG. 13 represents a cooling structure having a capacity of 1000 kW, FIG. 14 represents a cooling structure having a capacity of 500 kW, and FIG. 15 represents a cooling structure having a capacity of 300 kW.

FIG. 16 illustrates the electromagnetic thermal loss analysis results of the variable-capacity electric propulsion motor according to an exemplary embodiment of the present disclosure.

FIGS. 17 and 18 illustrate the temperature distribution analysis results of the variable-capacity electric propulsion motor according to an exemplary embodiment of the present disclosure, where FIG. 17 corresponds to Case #1 in Table 8, and FIG. 18 corresponds to Case #18 in Table 8.

FIGS. 19 through 21 illustrate the temperature distribution analysis results for the rated capacities of the variable-capacity electric propulsion motor according to an exemplary embodiment of the present disclosure, where FIG. 19 represents a temperature distribution analysis result corresponding to a capacity of 300 kW, FIG. 20 represents a temperature distribution analysis result corresponding to a capacity of 500 kW, and FIG. 21 represents a temperature distribution analysis result corresponding to a capacity of 1000 kW.

FIGS. 22 through 24 illustrate the temperature distribution analysis results for the overload capacities of the variable-capacity electric propulsion motor according to an exemplary embodiment of the present disclosure, where FIG. 22 represents a temperature distribution analysis result corresponding to a capacity of 300 kW, FIG. 23 represents a temperature distribution analysis result corresponding to a capacity of 500 kW, and FIG. 24 represents a temperature distribution analysis result corresponding to a capacity of 1000 kW.

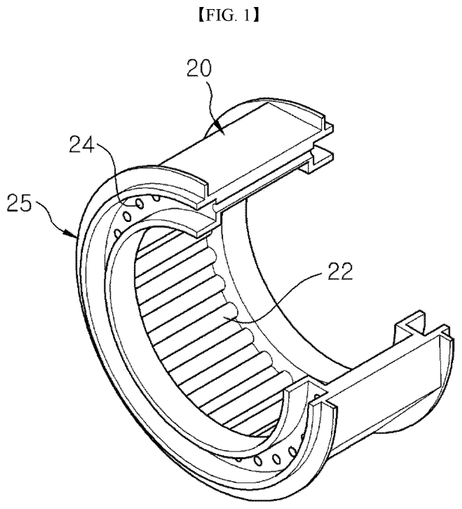

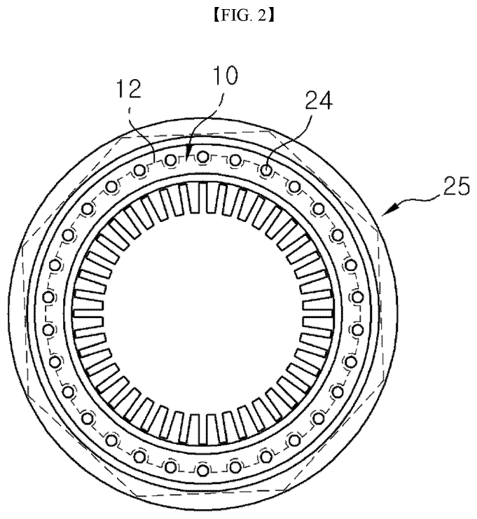

### BEST MODE

According to an exemplary embodiment of the present disclosure, the cooling structure of a variable-capacity electric propulsion motor is configured for cooling a variable-capacity electric propulsion motor. The variable-capacity electric propulsion motor may comprise: a rotor shaft; a rotor core formed in a shape of a circular plate, with the rotor shaft penetrating and being coupled at a center of the rotor core; a plurality of permanent magnets embedded along a circumferential direction of the rotor core; a winding coil arranged to surround an outer circumference of the rotor core; a stator core arranged to surround an outer circumference of the winding coil and to perform magnetic interaction with the plurality of permanent magnets; a motor housing formed in a hollow cylindrical shape with both ends open, arranged to surround an outer circumference of the stator core; and a pair of covers, each coupled to each of the both open ends of the motor housing, with the rotor shaft penetrating and being coupled at a center of each of the pair of covers, and with an accommodation space formed in the pair of covers, wherein the stator core is located in a same direction as an axis of the rotor shaft, wherein a plurality of cooling holes are formed at regular intervals along a circumferential direction of the stator core by penetrating through both faces of the stator core, wherein a plurality of cooling tubes are respectively coupled to the plurality of cooling holes, and wherein a cooling water introduced through one of the pair of covers flows through the cooling tubes and is discharged through another of the pair of covers.

### MODE FOR INVENTION

Hereinafter, exemplary embodiments of the present disclosure will be described in detail with reference to related drawings.

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but may further include any other component unless otherwise indicated.

Furthermore, it should be noted that when it is described that a component “exists in or is connected to” another component, this component may be directly connected or installed in contact with another component, and in inspect to a case where both components are installed spaced apart from each other by a predetermined distance, a third component or means for fixing or connecting the corresponding component to the other component may exist, and the description of the third component or means may be omitted.

On the contrary, when it is described that a component is “directly connected to” or “directly accesses” to another component, it should be understood that the third element or means does not exist.

Similarly, it should be construed that other expressions describing the relationship of the components, that is, expressions such as “between” and “directly between” or “adjacent to” and “directly adjacent to” also have the same purpose.

In addition, it should be noted that if terms such as “one side surface”, “other side surface”, “one side”, “other side”, “first”, “second”, etc., are used in this specification, the terms are used to clearly distinguish one component from the other component and a meaning of the corresponding component is not limited used by the terms.

Further, in this specification, if terms related to locations such as “upper”, “lower”, “left”, “right”, etc., are used, it should be understood that the terms indicate a relative location in the drawing with respect to the corresponding component and unless an absolute location is specified for their locations, these location-related terms should not be construed as referring to the absolute location.

Furthermore, in the specification of the present disclosure, terms such as “ . . . unit,” “ . . . device,” “module,” and “apparatus,” if used, refer to a unit capable of processing one or more functions or operations and should be understood to be implementable in hardware, software, or a combination of hardware and software.

Further, in this specification, in specifying the reference numerals for each component of each drawing, the same component has the same reference number even if the component is indicated in different drawings, that is, the same reference number indicates the same component throughout the specification.

In the drawings attached to this specification, a size, a location, a coupling relationship, etc. of each component constituting the present disclosure may be described while being partially exaggerated, reduced, or omitted for sufficiently clearly delivering the spirit of the present disclosure, and thus the proportion or scale may not be exact.

Further, hereinafter, in describing the present disclosure, a detailed description of a configuration determined that may unnecessarily obscure the subject matter of the present disclosure, for example, a detailed description of a known technology including the prior art may be omitted.

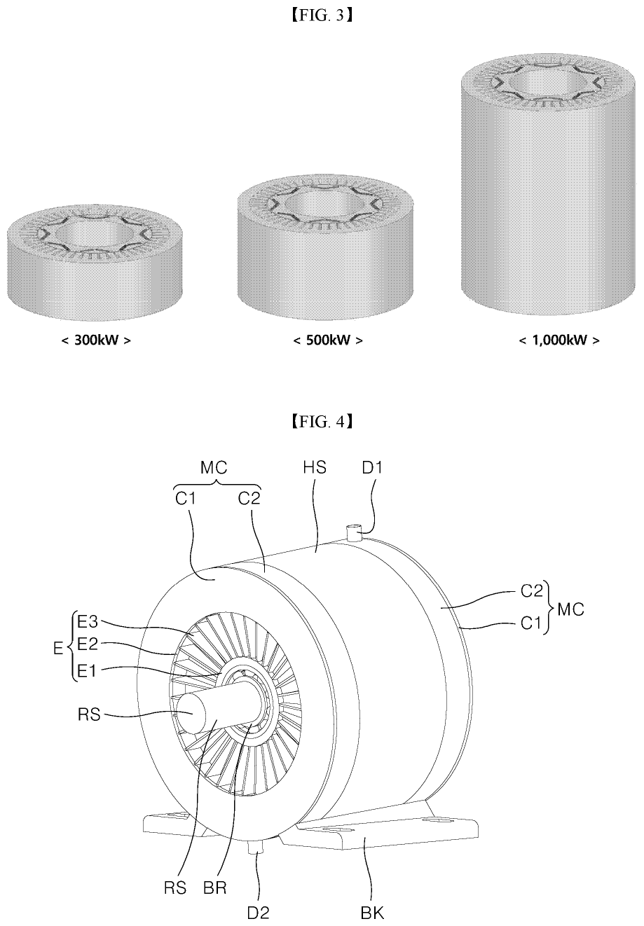

FIG. 3 illustrates a shape of a general variable-capacity electric propulsion motor.

As shown in FIG. 3, the electric propulsion motor is an interior permanent magnet-type motor with a structure in which the capacity varies according to the laminated length.

As described in Table 1 below, the design current density is 9 to 10 A/mm², necessitating a water-cooled cooling structure.

TABLE 1
Specifications of a general variable-
capacity electric propulsion motor

| | 300 kW model | | 500 kW model | | 1,000 kW model | |
|---|---|---|---|---|---|---|
| Stack Length | 202 | mm | 333 | mm | 720 | mm |
| Phase Current | 240 | A [symbol] | 400 | A [symbol] | 785 | A [symbol] |
| Current Density | 10.18 | A/mm [symbol] | 9.79 | A/mm [symbol] | 9.61 | A/mm [symbol] |
| Phase Back EMF | 722 | Vₘₐₓ | 722 | Vₘₐₓ | 723 | Vₘₐₓ |
| Torque | 2.448 | kNm | 4.084 | kNm | 8.123 | kNm |
| Output Power | 307 | kW | 513 | kW | 1020 | kW |
| Copper Loss | 6.594 | kW | 7.738 | kW | 12.282 | kW |
| Core Loss | 1.201 | kW | 2.012 | kW | 4.093 | kW |
| PM Loss | 0.046 | kW | 0.87 | kW | 0.129 | kW |

| | | | |
|---|---|---|---|
| Efficiency | 97.51% | 98.12% | 98.41% |
| Power Factor | 85.02% | 89.11% | 86.72% |

[symbol]

indicates data missing or illegible when filed

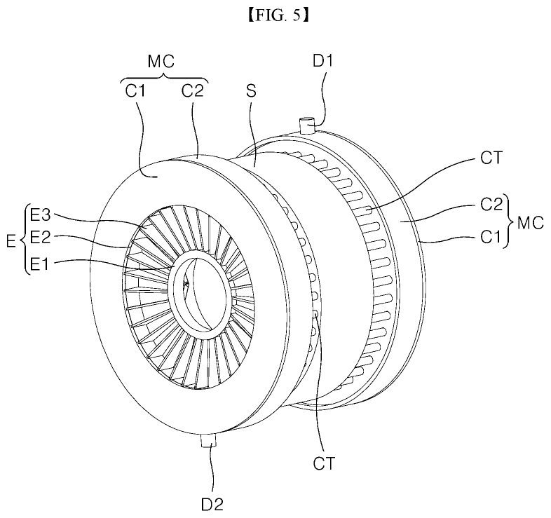

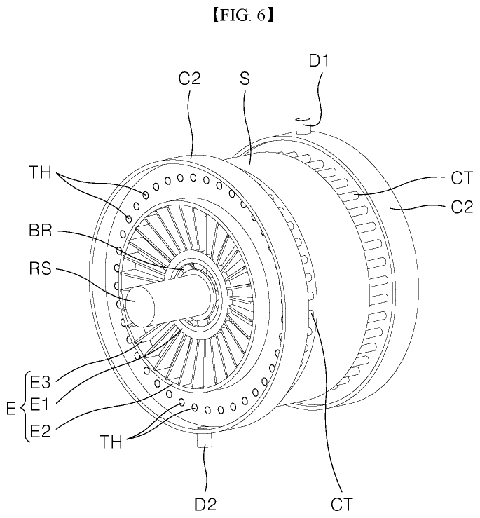

FIG. 4 illustrates a variable-capacity electric propulsion motor according to an exemplary embodiment of the present disclosure, and FIG. 5 illustrates a state where a cooling tube is coupled to the stator core in the variable-capacity electric propulsion motor according to an exemplary embodiment of the present disclosure.

The variable-capacity electric propulsion motor according to an exemplary embodiment of the present disclosure may include a rotor shaft (RS), a rotor core (R), a plurality of permanent magnets (PM), a winding coil (WC), a stator core (S), a motor housing (HS), and a pair of covers (MC).

The rotor core (R) may be formed in a shape of a circular plate, with the rotor shaft (RS) penetrating and coupled at the center of the rotor core (R).

A plurality of insertion holes (IH), penetrating through the front and rear surfaces, may be formed along the circumferential direction of the rotor core (R).

The plurality of permanent magnets (PM) may be respectively embedded in the plurality of insertion holes (IH) formed along the circumferential direction of the rotor core (R).

The winding coil (WC) may be arranged to surround the outer circumference of the rotor core (R).

The stator core (S) may be arranged to surround the outer circumference of the winding coil (WC) and may interact magnetically with the permanent magnets (PM).

The capacity of the motor can vary depending on the laminated length, which is determined by the number of laminations of the rotor core (R) and the stator core (S).

In other words, the capacity of the variable-capacity electric propulsion motor can vary according to a laminated length depending on a number of the rotor core (R) and the stator core (S) being laminated.

The motor housing (HS) may be formed as a hollow cylindrical shape with both ends open and may be arranged to surround the outer circumference of the stator core (S).

The pair of covers (MC) may be respectively coupled to the open ends of the motor housing (HS), with the rotor shaft (RS) penetrating and coupled at the center, and an internal accommodation space formed within.

In other words, each of the pair of covers (MC) may be coupled to each of the both open ends of the motor housing (HS), with the rotor shaft (RS) penetrating and being coupled at a center of each of the pair of covers (MC), and with an accommodation space formed in the pair of covers (MC).

The cover (MC) may include an inner cover (C2) coupled to the open side of the motor housing (HS) and an outer cover (C1) coupled to the inner cover (C2). The outer cover (C1) may be formed in a shaped corresponding to the inner cover (C2).

In addition, the outer cover (C1) may be formed to cover the space between the second protruding rib (E2) of a heat dissipating portion (E) (to be described below) and the edge portion of the inner cover (C2).

One of the pair of inner covers (C2) may include a cooling water inlet (D1), while the other one of the pair of inner cover (C2) may include a cooling water outlet (D2).

In other words, the cooling water inlet (D1) may be formed at one of a pair of the inner covers (C2), and the cooling water outlet (D2) may be formed at the other one of the pair of the inner covers (C2).

The side where the cooling water inlet (D1) is formed may be the non-driven end (NDE) of the motor, and the side where the cooling water outlet (D2) is formed may be the driven end (DE) of the motor.

In other words, the cooling water inlet (D1) may be formed at a non-driven end (NDE) of the motor, and the cooling water outlet (D2) may be formed at a driven end (DE) of the motor.

The cooling water may flow from the non-driven end (NDE) to the driven end (DE).

FIG. 6 illustrates an interior of an inner cover in the variable-capacity electric propulsion motor according to an exemplary embodiment of the present disclosure.

The inner cover (C2) may be formed to include a base portion that covers the open side of the motor housing (HS) and an edge portion extending a predetermined length in the axial direction of the rotor shaft (RS) from the perimeter of the base portion.

The base portion may include a plurality of fitting holes (TH) formed at positions corresponding to the plurality of cooling tubes (CT), and the ends of the cooling tubes (CT) may be fitted into these fitting holes (TH).

The base portion may include a heat dissipating portion (E) formed to release heat generated inside the variable-capacity electric propulsion motor.

The heat dissipating portion (E) may include: a first protruding rib (E1) extending from the base portion in the same direction as the edge portion along the perimeter of the rotor shaft (RS); a second protruding rib (E2) extending from the base portion in the same shape as the first protruding rib (E1), located between the first protruding rib (E1) and the fitting holes (TH); and a plurality of heat dissipation ribs (E3) spaced apart from one another, connecting the first protruding rib (E1) and the second protruding rib (E2).

Here, a bearing (BR) may be coupled between the rotor shaft (RS) and the first protruding rib (E1).

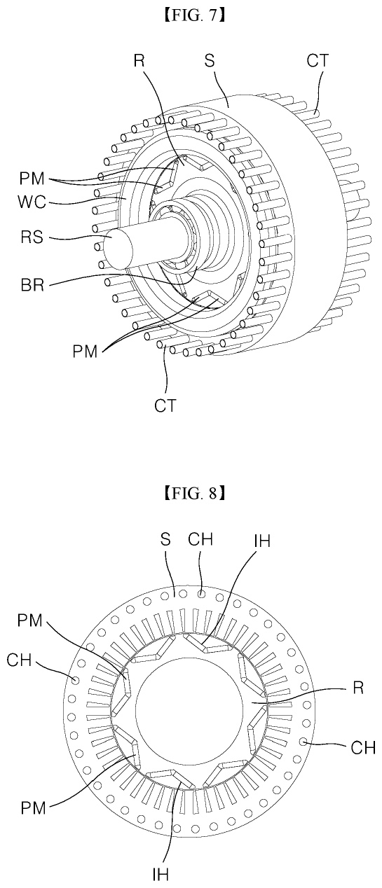

FIG. 7 illustrates an assembled state where a stator core, a winding coil, a rotor core, and a permanent magnet are coupled with the cooling tube in the variable-capacity electric propulsion motor according to an exemplary embodiment of the present disclosure.

FIG. 8 illustrates a state where a stator core with cooling holes, a rotor core, and a permanent magnet are coupled in the variable-capacity electric propulsion motor according to an exemplary embodiment of the present disclosure.

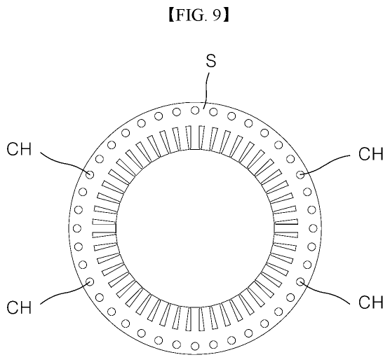

FIG. 9 illustrates the stator core in the variable-capacity electric propulsion motor according to an exemplary embodiment of the present disclosure.

A plurality of cooling holes (CH) may be formed at regular intervals along the circumferential direction, penetrating through both faces of the stator core (S) located in the same direction as the axial direction of the rotor shaft (RS). Each of these cooling holes (CH) may be coupled with a cooling tube (CT).

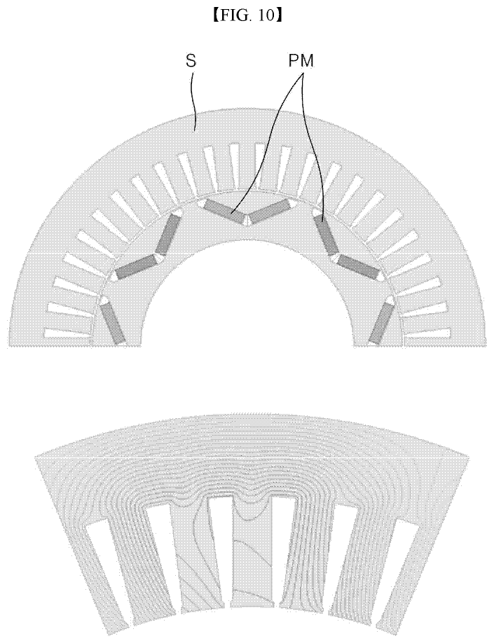

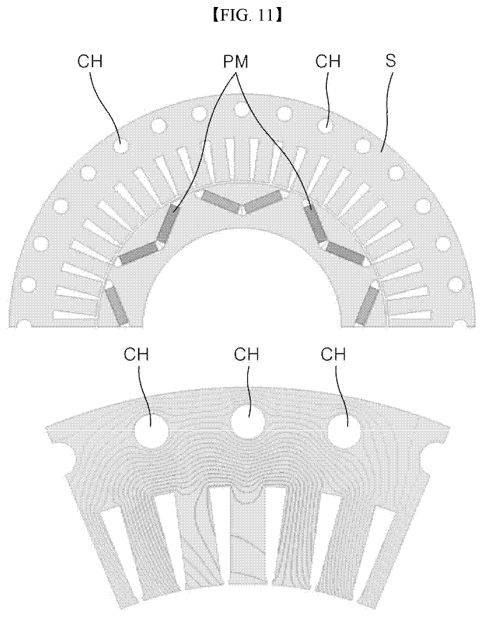

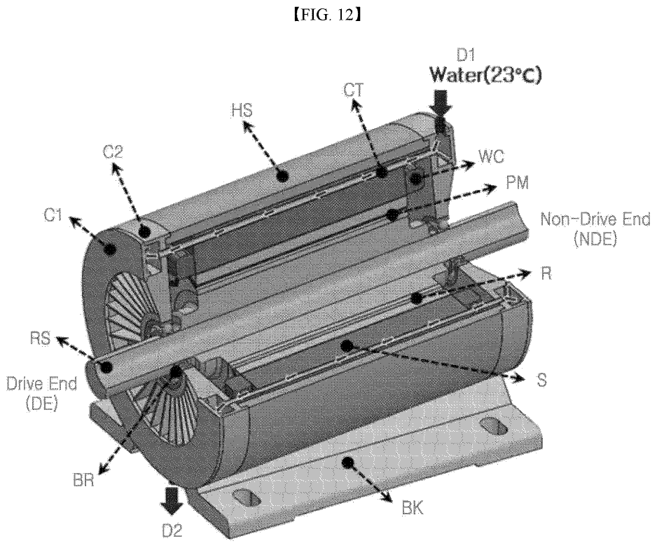

FIG. 10 illustrates an assembled state of a stator core, a rotor core, and a permanent magnet, as well as the magnetic flux distribution, in a general electric propulsion motor, and FIG. 11 illustrates an assembled state of a stator core, a rotor core, and a permanent magnet, as well as the magnetic flux distribution, in the variable-capacity electric propulsion motor according to an exemplary embodiment of the present disclosure.

According to an exemplary embodiment of the present disclosure, cooling holes (CH) that do not affect the motor characteristics were formed inside the stator core (S) (stator yoke).

In addition, a circular cooling hole structure was applied to allow the insertion of cylindrical cooling tubes (CT), and the cooling efficiency was maximized by increasing the number of cooling holes (CH).

TABLE 2
Performance comparison between the conventional model
of electric propulsion motor and the cooling structure
model according to the present disclosure

| | Conventional | | Cooling | |
|---|---|---|---|---|
| | Model | | Structure Model | |
| Material of Stator and Rotor Core | 35PN250 | | | |
| Permanent Magnet Material | N38UH (20° C.) (B [symbol] : 1.26 T) | | | |
| Coil Material | Copper | | | |
| Counter Electromotive Force | 335 Vₘₐₓ/232 V [symbol] | | 335 Vₘₐₓ/232 V [symbol] | |
| Input Phase Current | 940 | A [symbol] | 940 | A [symbol] |
| Torque | 4.34 | kNm | 4.34 | kNm |
| Torque Ripple | 10.68% | | 11.03% | |
| Speed | 1200 | rpm | 1200 | rpm |
| Output Power | 545.056 | kW | 545.656 | kW |
| Copper Loss | 9.719 | kW | 9.719 | kW |
| Iron Loss | 1.993 | kW | 1.973 | kW |
| Permanent Magnet Loss | 0.120 | kW | 0.106 | kW |
| Input Power | 556.888 | kW | 557.454 | kW |

| | | |
|---|---|---|
| Efficiency | 97.87% | 97.88% |

[symbol]

indicates data missing or illegible when filed

FIG. 12 illustrates a cooling structure of a variable-capacity electric propulsion motor according to an exemplary embodiment of the present disclosure.

When the cooling water enters through the cooling water inlet (D1) formed in the cover (MC) located on the non-driven end (NDE), the cooling water fills the accommodation space inside the cover (MC) at the non-driven end. The cooling water then flows through the cooling tubes (CT) fitted into the fitting holes (TH) of the inner cover (C2) and fills the accommodation space inside the cover (MC) located at the driven end (DE). Finally, the cooling water is discharged through the cooling water outlet (D2) formed at the cover (MC) at the driven end.

As described above, by coupling cooling tubes (CT) to the cooling holes (CH) formed at the stator core (S), the distance to the internal heat-generating components (such as the winding coil or permanent magnets) of the electric propulsion motor is reduced, thereby increasing cooling efficiency.

TABLE 3
Specifications of the variable-capacity electric propulsion
motor according to the present disclosure

| | | Elastic | Possion's | | Thermal |
|---|---|---|---|---|---|
| Component | Materials | Modulus | Ratio | Density | Conductivity |
| (Parts) | (ASME, JIS) | [GPa] | [—] | [kg/m³] | [W/(m · ° C.)] |
| Winding Coil | Copper | 110.0 | 0.37 | 8,900 | |
| Shaft | Steel | 210.0 | 0.29 | 7,700 | 51.9 |
| | (SM45C) | | | | |
| Bearing | Steel | 210.0 | 0.29 | 7,700 | |
| | (SM45C) | | | | |
| Rotor Core | Iron | 200.0 | 0.29 | 7,890 | 48.0 |
| | (35PN250) | | | | |
| Stator Core | Iron | 200.0 | 0.29 | 7,890 | |
| | (35PN250) | | | | |
| Coolant | Brass | 72.4 | 0.32 | 8,100 | |
| Tube | | | | | |
| PM | Alliance | 152.0 | 0.30 | 7,500 | 10.0 |
| | N-30H | | | | |
| | (NdFeB) | | | | |
| Housing | AL-alloy | 70.0 | 0.33 | 2,680 | |
| | (AC4C, 5052) | | | | |
| Inside & | AL-alloy | 70.0 | 0.33 | 2,680 | |
| Outside | (AC4C, 5052) | | | | |
| Cover | | | | | |
| Bracket | AL-alloy | 70.0 | 0.33 | 2,680 | |
| | (AC4C, 5052) | | | | |

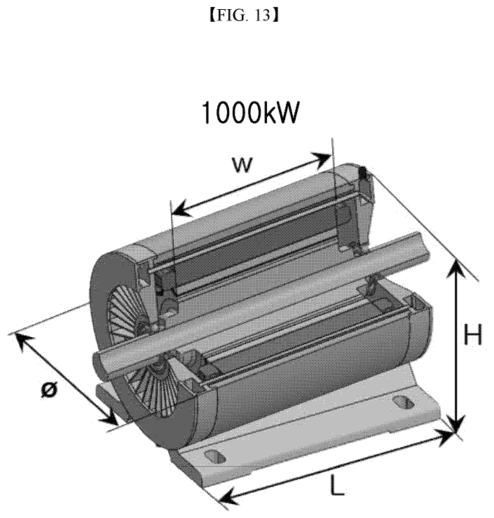

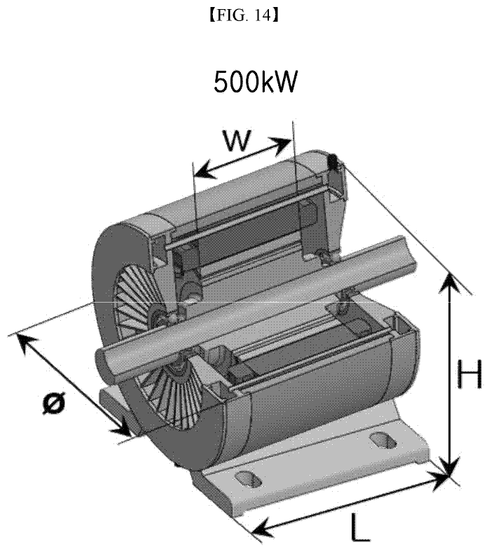

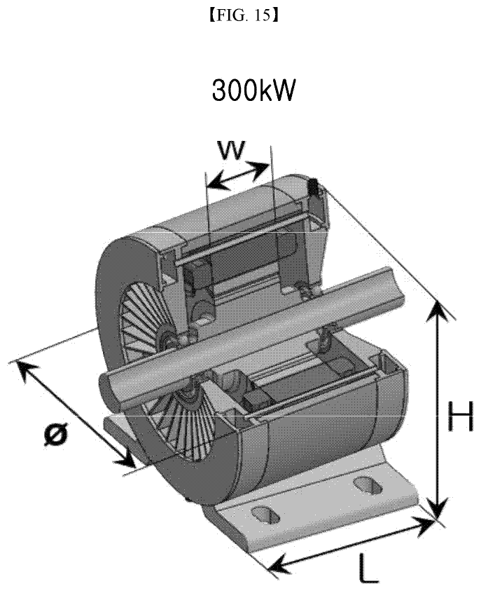

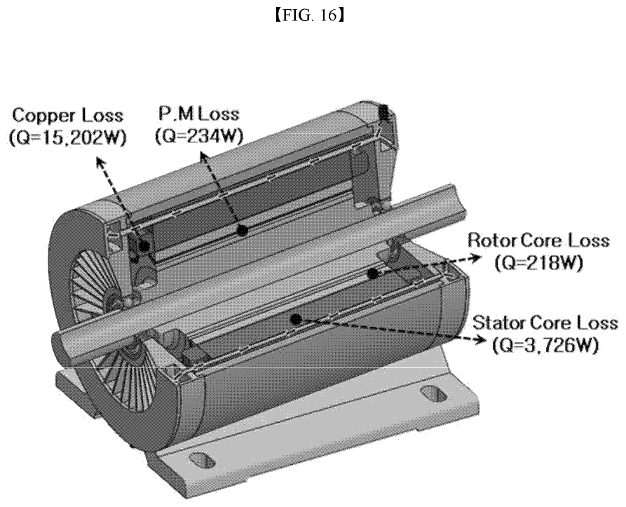

FIGS. 13 through 15 illustrate cooling structures corresponding to variable capacities, where FIG. 13 represents a cooling structure having a capacity of 1000 kW, FIG. 14 represents a cooling structure having a capacity of 500 kW, and FIG. 15 represents a cooling structure having a capacity of 300 kW.

The variable-capacity electric propulsion motor according to an exemplary embodiment of the present disclosure pertains to an interior permanent magnet-type electric propulsion motor with a structure in which the capacity varies according to the laminated length, thereby eliminating the need for additional cooling structure design for variable capacities.

TABLE 4
Dimensions of the variable-capacity electric propulsion motor

| Motor | | Height | Length | Stator |
|---|---|---|---|---|
| Power | Diameter(ø) | (H) | (L) | Width(W) |
| 300[kW] | 670 mm | 710 mm | 476 mm | 180 mm |
| 500[kW] | 670 mm | 710 mm | 596 mm | 300 mm |
| 1,000[kW] | 670 mm | 710 mm | 896 mm | 600 mm |

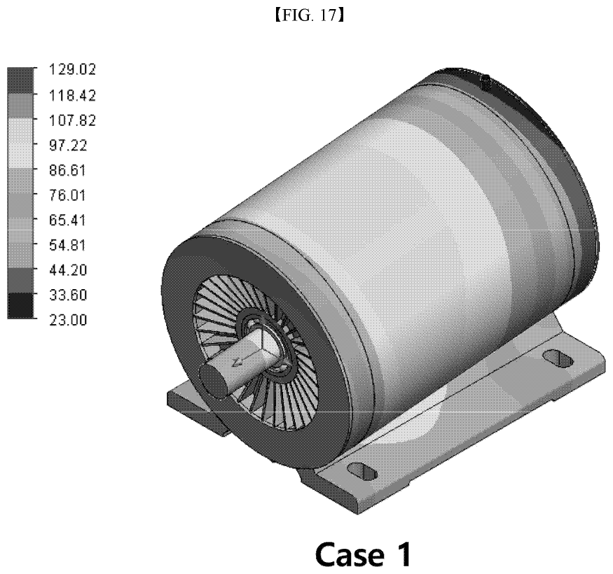

FIG. 16 illustrates the electromagnetic thermal loss analysis results of the variable-capacity electric propulsion motor according to an exemplary embodiment of the present disclosure.

Table 5 below shows the electromagnetic losses of the three main heat-generating components of the motor (winding coil, core, and permanent magnet) under rated load and overload conditions.

TABLE 5
Electromagnetic thermal loss analysis results
of the variable-capacity electric

| Motor Power | | Copper Loss | Iron Loss [W] | | PM Loss |
|---|---|---|---|---|---|
| [kW] | | [W] | Stator | Rotor | [W] |
| 300 | Rated (100%) | 8,740 | 1,150 | 69 | 80 |
| | Overload (150%) | 16,233 | 1,347 | 89 | 152 |
| 500 | Rated (100%) | 9,749 | 1,863 | 109 | 118 |
| | Overload (150%) | 19,959 | 2,244 | 148 | 253 |
| 1,000 | Rated (100%) | 15,202 | 3,726 | 218 | 234 |
| | Overload (150%) | 29,978 | 4,447 | 294 | 488 |

The cooling effect was analyzed based on the diameter, number, and flow rate of the cooling tubes.

TABLE 6
Specifications of cooling tubes (inlet/outlet tube)
The inlet/outlet tube

| No. Size | O.D | Thick. | Tolerance | Pressure |
|---|---|---|---|---|
| (inch) | (mm) | (mm) | (±mm) | (kg/cm²) |
| ¾ | 22.22 | 1.65 | 0.18 | 58.7 |
| 1 | 25.58 | | 0.18 | 45.1 |
| 1¼ | 34.92 | | 0.18 | 36.6 |

TABLE 7
Specifications of cooling tubes (branch tubes)
The branch tubes

| No. Size | O.D | Thick. | Tolerance | Pressure |
|---|---|---|---|---|
| (inch) | (mm) | (mm) | (±mm) | (kg/cm²) |
| ⅜ | 12.70 | 1.24 | 0.13 | 79.7 |
| ½ | 15.88 | | 0.15 | 61.6 |
| ⅝ | 19.05 | | 0.15 | 50.9 |

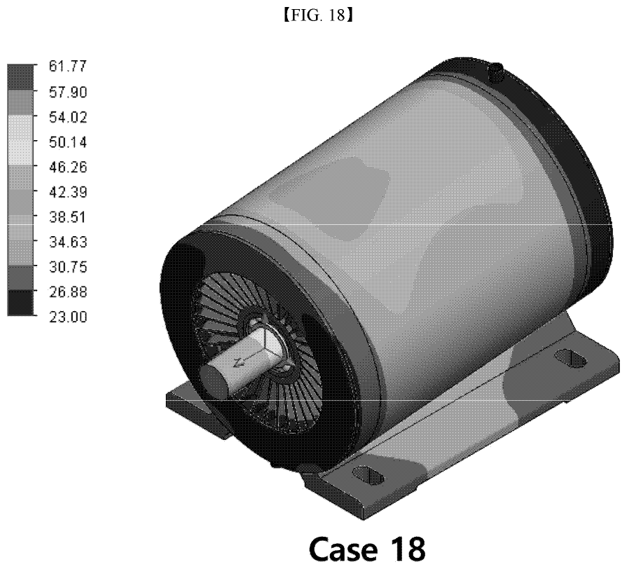

FIGS. 17 and 18 illustrate the temperature distribution analysis results of the variable-capacity electric propulsion motor according to an exemplary embodiment of the present disclosure, where FIG. 17 corresponds to Case #1 in Table 8, and FIG. 18 corresponds to Case #18 in Table 8.

TABLE 8
Various cases (#1~#18) combining cooling tube diameter,
cooling water velocity, and winding coil temperature in the variable-
capacity electric propulsion motor according to the present disclosure

| | Tube's | | Tube | Coolant | Winding Coil Temp. | | |
|---|---|---|---|---|---|---|---|
| Analysis | Diameter [mm] | | No. | Velocity | (° C.) | | |
| No. | Inlet | Branch | (N [symbol] ) | (V_{m/s}) | D.E | N.D.E | ΔT |
| #1 | D [symbol] | d [symbol] | N [symbol] | V [symbol] | 128.5 | 103.4 | 25.1 |
| #2 | | | | V [symbol] | 113.0 | 88.4 | 24.6 |
| #3 | | | | V [symbol] | 99.9 | 80.6 | 19.3 |
| #4 | D [symbol] | d [symbol] | N [symbol] | V [symbol] | 122.6 | 100.8 | 21.8 |
| #5 | | | | V [symbol] | 106.2 | 82.1 | 24.1 |
| #6 | | | | V [symbol] | 102.0 | 79.4 | 22.6 |
| #7 | D [symbol] | d [symbol] | N [symbol] | V [symbol] | 114.8 | 87.6 | 27.2 |
| #8 | | | | V [symbol] | 107.8 | 77.0 | 30.8 |
| #9 | | | | V [symbol] | 92.8 | 71.2 | 21.6 |
| #10 | D [symbol] | d [symbol] | N [symbol] | V [symbol] | 109.2 | 85.2 | 24.0 |
| #11 | | | | V [symbol] | 101.3 | 72.5 | 28.8 |
| #12 | | | | V [symbol] | 97.9 | 71.7 | 26.2 |
| #13 | D [symbol] | d [symbol] | N [symbol] | V [symbol] | 74.3 | 67.2 | 7.1 |
| #14 | | | | V [symbol] | 64.4 | 62.9 | 1.5 |
| #15 | | | | V [symbol] | 61.6 | 59.9 | 1.7 |
| #16 | D [symbol] | d [symbol] | N [symbol] | V [symbol] | 71.8 | 64.7 | 7.1 |
| #17 | | | | V [symbol] | 62.7 | 61.3 | 1.4 |
| #18 | | | | V [symbol] | 61.3 | 59.9 | 1.4 |

[symbol]

indicates data missing or illegible when filed

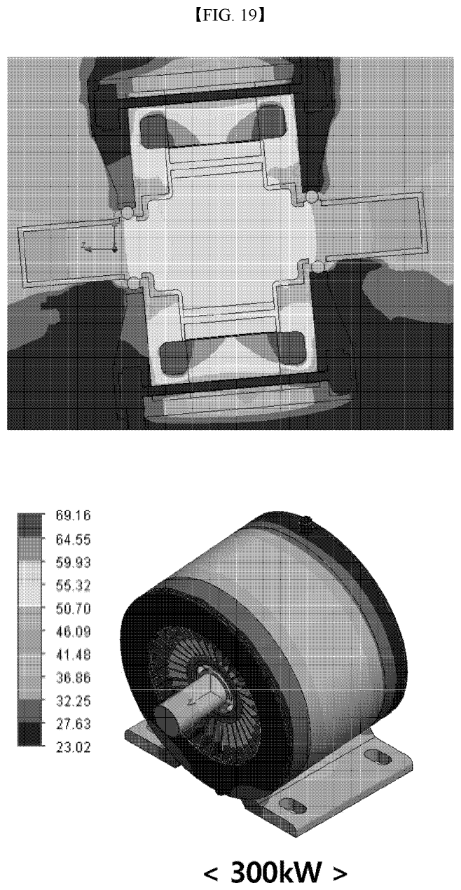

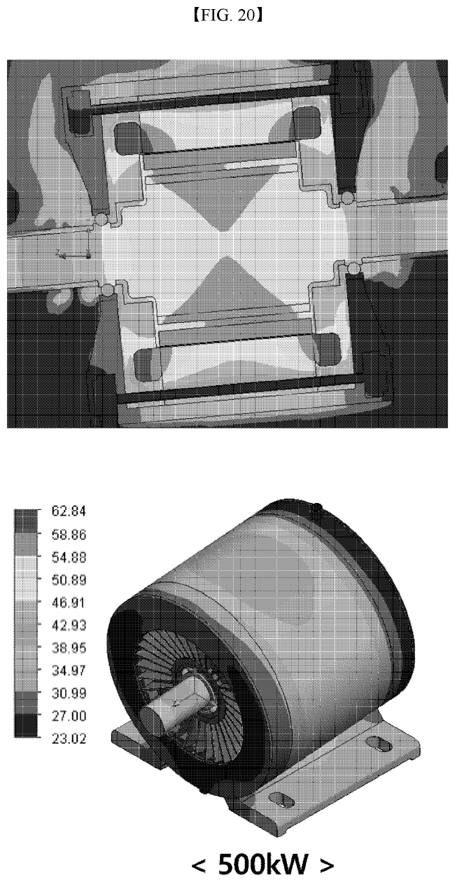

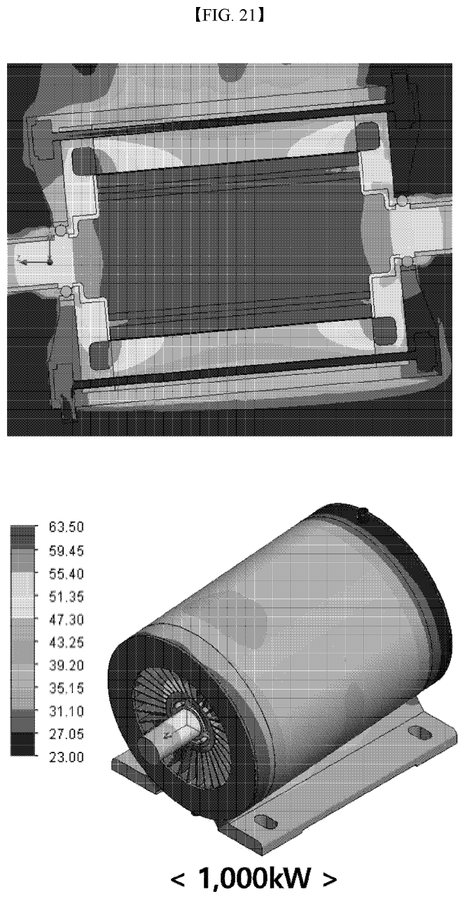

FIGS. 19 through 21 illustrate the temperature distribution analysis results for the rated capacities of the variable-capacity electric propulsion motor according to an exemplary embodiment of the present disclosure, where FIG. 19 represents a temperature distribution analysis result corresponding to a capacity of 300 kW, FIG. 20 represents a temperature distribution analysis result corresponding to a capacity of 500 kW, and FIG. 21 represents a temperature distribution analysis result corresponding to a capacity of 1000 kW.

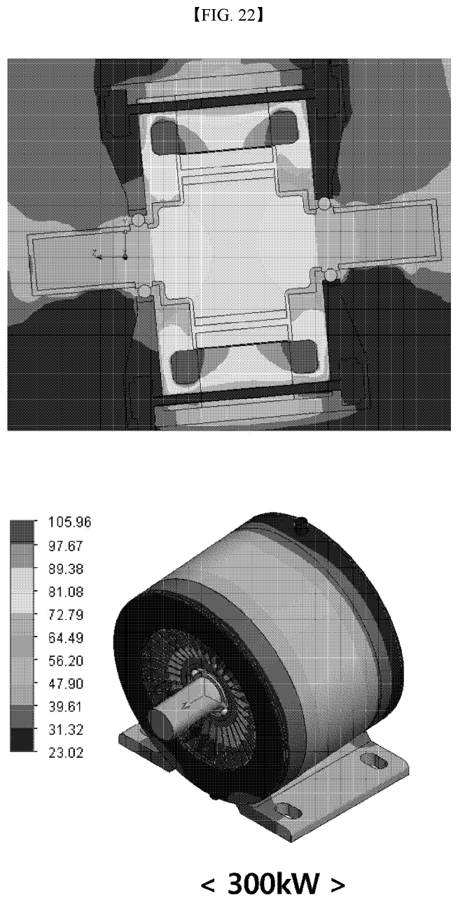

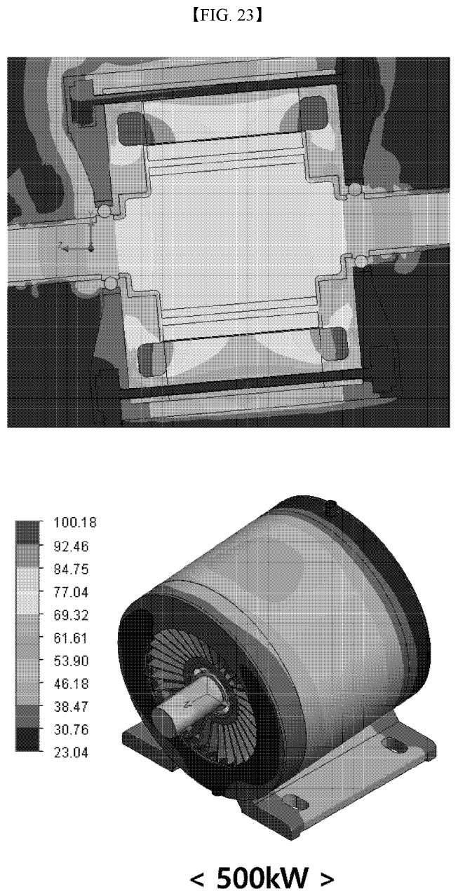

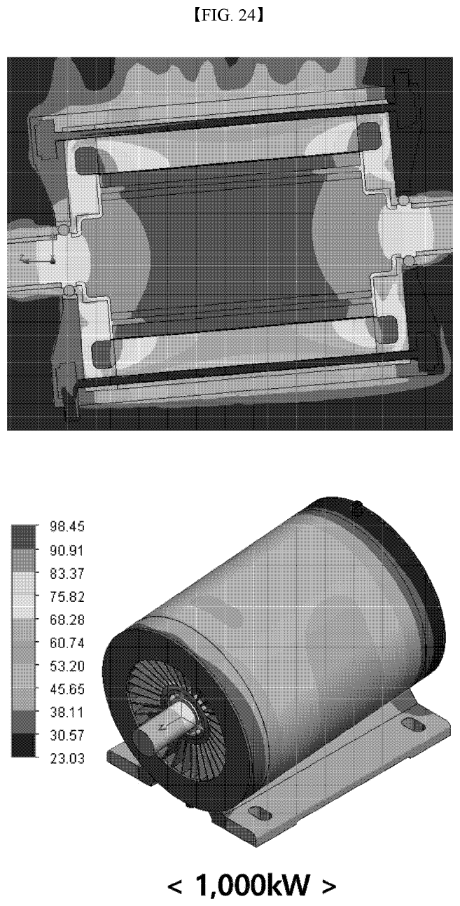

FIGS. 22 through 24 illustrate the temperature distribution analysis results for the overload capacities of the variable-capacity electric propulsion motor according to an exemplary embodiment of the present disclosure, where FIG. 22 represents a temperature distribution analysis result corresponding to a capacity of 300 kW, FIG. 23 represents a temperature distribution analysis result corresponding to a capacity of 500 kW, and FIG. 24 represents a temperature distribution analysis result corresponding to a capacity of 1000 kW.

TABLE 9
Electromagnetic thermal losses by motor capacity
(rated capacity/overload capacity)

| Motor Power | | Copper Loss | Iron Loss [W] | | PM Loss |
|---|---|---|---|---|---|
| [kW] | | [W] | Stator | Rotor | [W] |
| 300 | Rated (100%) | 8,740 | 1,150 | 69 | 80 |
| | Overload (150%) | 16,233 | 1,347 | 89 | 152 |
| 500 | Rated (100%) | 9,749 | 1,863 | 109 | 118 |
| | Overload (150%) | 19,959 | 2,244 | 148 | 253 |
| 1,000 | Rated (100%) | 15,202 | 3,726 | 218 | 234 |
| | Overload (150%) | 29,978 | 4,447 | 294 | 488 |

TABLE 10
Temperature analysis by motor capacity
(rated capacity/overload capacity)

| | | | | Temp. |
|---|---|---|---|---|
| Motor Power | | Directional Temp. [° C.] | | Differences |
| [kW] | | D.E Coil | N.D.E Coil | (ΔT) |
| 300 | Rated (100%) | 67.5 | 68.1 | −0.6 |
| | Overload (150%) | 103.5 | 103.5 | 0 |
| 500 | Rated (100%) | 62.4 | 61.6 | 0.8 |
| | Overload (150%) | 99.2 | 96.8 | 2.4 |
| 1,000 | Rated (100%) | 62.7 | 61.4 | 1.3 |
| | Overload (150%) | 97.4 | 93.6 | 3.8 |

In the above, although several preferred embodiments of the present disclosure have been described with some examples, the descriptions of various exemplary embodiments described in the “Specific Content for Carrying Out the Invention” item are merely exemplary, and it will be appreciated by those skilled in the art that the present disclosure can be variously modified and carried out or equivalent executions to the present disclosure can be performed from the above description.

In addition, since the present disclosure can be implemented in various other forms, the present disclosure is not limited by the above description, and the above description is for the purpose of completing the disclosure of the present disclosure, and the above description is just provided to completely inform those skilled in the art of the scope of the present disclosure, and it should be known that the present disclosure is only defined by each of the claims.

### INDUSTRIAL APPLICABILITY

The present disclosure relates to a cooling structure for a variable-capacity electric propulsion motor and a variable-capacity electric propulsion motor employing the cooling structure. By forming a plurality of cooling holes in the stator core and configuring the cooling tubes to be coupled to these cooling holes, the cooling efficiency can be maximized without affecting the motor characteristics. In addition, as an interior permanent magnet-type electric propulsion motor with a structure in which the capacity varies according to the laminated length, the variable-capacity electric propulsion motor eliminates the need for additional cooling structure design for variable capacities, offering industrial applicability.

1. A cooling structure for cooling a variable-capacity electric propulsion motor, the variable-capacity electric propulsion motor comprising:
a rotor shaft;
a rotor core formed in a shape of a circular plate, with the rotor shaft penetrating and being coupled at a center of the rotor core;
a plurality of permanent magnets embedded along a circumferential direction of the rotor core;
a winding coil arranged to surround an outer circumference of the rotor core;
a stator core arranged to surround an outer circumference of the winding coil and to perform magnetic interaction with the plurality of permanent magnets;
a motor housing formed in a hollow cylindrical shape with both ends open, arranged to surround an outer circumference of the stator core; and
a pair of covers, each coupled to each of the both open ends of the motor housing, with the rotor shaft penetrating and being coupled at a center of each of the pair of covers, and with an accommodation space formed in the pair of covers,
wherein the stator core is located in a same direction as an axis of the rotor shaft,
wherein a plurality of cooling holes are formed at regular intervals along a circumferential direction of the stator core by penetrating through both faces of the stator core,
wherein a plurality of cooling tubes are respectively coupled to the plurality of cooling holes, and
wherein a cooling water introduced through one of the pair of covers flows through the cooling tubes and is discharged through another of the pair of covers.

2. The cooling structure of claim 1, wherein each of the pair of covers includes:
an inner cover coupled to an open side of the motor housing; and
an outer cover formed in a shape corresponding to the inner cover and coupled to the inner cover.

3. The cooling structure of claim 2, wherein the inner cover includes:
a base portion covering the open side of the motor housing; and
an edge portion extending a predetermined length in an axial direction of the rotor shaft from a perimeter of the base portion.

4. The cooling structure of claim 3,
wherein the base portion includes a plurality of fitting holes formed at positions corresponding to the plurality of cooling tubes, and
wherein ends of the plurality of cooling tubes are respectively fitted into the plurality of fitting holes.

5. The cooling structure of claim 4,
wherein the base portion includes a heat dissipating portion formed to release heat generated in the variable-capacity electric propulsion motor.

6. The cooling structure of claim 5, wherein the heat dissipating portion includes:
a first protruding rib extending from the base portion in a same direction as the edge portion along a perimeter of the rotor shaft;
a second protruding rib located between the first protruding rib and the fitting holes, extending from the base portion and formed in a same shape as the first protruding rib; and
a plurality of heat dissipating ribs, each of which is spaced apart from one another and connecting the first protruding rib and the second protruding rib.

7. The cooling structure of claim 6,
wherein the outer cover is formed to cover a space between the second protruding rib and the edge portion.

8. The cooling structure of claim 2,
wherein a cooling water inlet is formed at one of a pair of the inner covers, and a cooling water outlet is formed at another one of the pair of the inner covers.

9. A variable-capacity electric propulsion motor, comprising:
a rotor shaft;
a rotor core formed in a shape of a circular plate, with the rotor shaft penetrating and being coupled at a center of the rotor core;
a plurality of permanent magnets embedded along a circumferential direction of the rotor core;
a winding coil arranged to surround an outer circumference of the rotor core;
a stator core arranged to surround an outer circumference of the winding coil and to perform magnetic interaction with the plurality of permanent magnets;
a motor housing formed in a hollow cylindrical shape with both ends open, arranged to surround an outer circumference of the stator core; and
a pair of covers, each coupled to each of the both open ends of the motor housing, with the rotor shaft penetrating and being coupled at a center of each of the pair of covers, and with an accommodation space formed in the pair of covers,
wherein the stator core is located in a same direction as an axis of the rotor shaft,
wherein a plurality of cooling holes are formed at regular intervals along a circumferential direction of the stator core by penetrating through both faces of the stator core, and
wherein a plurality of cooling tubes are respectively coupled to the plurality of cooling holes.

10. The variable-capacity electric propulsion motor of claim 9, wherein each of the pair of covers includes:
an inner cover coupled to an open side of the motor housing; and
an outer cover formed in a shape corresponding to the inner cover and coupled to the inner cover.

11. The variable-capacity electric propulsion motor of claim 10, wherein the inner cover includes:
a base portion covering the open side of the motor housing; and
an edge portion extending a predetermined length in an axial direction of the rotor shaft from a perimeter of the base portion.

12. The variable-capacity electric propulsion motor of claim 11,
wherein the base portion includes a plurality of fitting holes formed at positions corresponding to the plurality of cooling tubes, and
wherein ends of the plurality of cooling tubes are respectively fitted into the plurality of fitting holes.

13. The variable-capacity electric propulsion motor of claim 11,
wherein the base portion includes a heat dissipating portion formed to release heat generated in the variable-capacity electric propulsion motor.

14. The variable-capacity electric propulsion motor of claim 13, wherein the heat dissipating portion includes:
a first protruding rib extending from the base portion in a same direction as the edge portion along a perimeter of the rotor shaft;
a second protruding rib located between the first protruding rib and the fitting holes, extending from the base portion and formed in a same shape as the first protruding rib; and
a plurality of heat dissipating ribs, each of which is spaced apart from one another and connecting the first protruding rib and the second protruding rib.

15. The variable-capacity electric propulsion motor of claim 14,
wherein the outer cover is formed to cover a space between the second protruding rib and the edge portion.

16. The variable-capacity electric propulsion motor of claim 10,
wherein a cooling water inlet is formed at one of a pair of the inner covers, and a cooling water outlet is formed at another one of the pair of the inner covers.

17. The variable-capacity electric propulsion motor of claim 14,
wherein a bearing is coupled between the rotor shaft and the first protruding rib.

18. The variable-capacity electric propulsion motor of claim 16,
wherein the cooling water inlet is formed at a non-driven end, and the cooling water outlet is formed at a driven end, and
wherein the cooling water flows from the non-driven end to the driven end.

19. The variable-capacity electric propulsion motor of claim 9,
wherein a capacity of the variable-capacity electric propulsion motor varies according to a laminated length depending on a number of the rotor core and the stator core being laminated.
